(19) United States
(12) Patent Application Publication
(10) Pub. No.: US 2024/0127335 A1
(43) Pub. Date: Apr. 18, 2024

(54) USAGE OF EMOTION RECOGNITION IN TRADE MONITORING

(71) Applicant: Actimize LTD., Ra'anana (IL)

(72) Inventors: Anurag MOHAPATRA, Livingston, NJ (US); Steve LOGALBO, McKinney, TX (US)

(21) Appl. No.: 18/046,195

(22) Filed: Oct. 13, 2022

(51) Int. Cl. G06Q 40/04; G10L 25/63

(52) U.S. Cl. CPC G06Q 40/04; G10L 25/63

(57) ABSTRACT

Trade monitoring systems and methods, and non-transitory computer readable media, include receiving a plurality of audio communications associated with a trader; scoring one or more emotions in each audio communication; creating a base emotional profile for the trader based on the scoring; receiving a current audio communication associated with the trader; scoring the one or more emotions in the current audio communication; comparing the base emotional profile to the scored one or more emotions in the current audio communication; detecting a score for an emotion in the current audio communication that is inconsistent with the base emotional profile; assigning an emotion risk score that indicates a high likelihood the trader in the current audio communication is involved in securities fraud; and generating an alert of potential securities fraud by the trader in the current audio communication.

### TECHNICAL FIELD

The present disclosure relates generally to methods and systems for trade monitoring, and more specifically relates to methods and systems that use emotions to detect potential securities fraud.

### BACKGROUND

Financial institutions such as asset management firms and retail banks that are engaged in trading on the stock markets or other assets are required by regulators to monitor trades to ensure that they and their employees are not misusing knowledge or their position to manipulate the market to their advantage.

Identification of the conduct of traders/employees is required by regulators and increased focus on conduct risk is evidenced by regulations like the Senior Manager Certification Regime (SM&CR). In addition, regulations like the European Securities and Markets Authority (ESMA) Market Abuse Regulations require that financial firms need to understand the intent of a trader's actions. By requiring firms to understand the intent behind their employees' trades, regulators are tasking banks to demonstrate that the trades were carried out for a legitimate reason and that none of the traders are manipulating prices.

To protect against potential securities fraud, firms use trade surveillance solutions that monitor traders to detect if any known patterns of manipulation exist in the trades. Firms are also required to record the conversations of traders, and traders must use company-issued phones for business conversations. In the current landscape, firms use speech to text conversions and techniques like lexicon-based search or natural language processing to detect patterns of conversation that could indicate manipulation.

These solutions, however, are filled with problems like high false positive rates, inability to detect true cases of manipulation, and most importantly, they cannot detect the intent of the trade. To understand true intent, one needs to understand the state of mind of a trader. The current market solutions (e.g., trade and communication analysis) are focused on the actions of traders and fail to identify the reasons or motivation behind those trades.

Accordingly, a need exists for improved systems and methods that will assist in the detection of securities fraud.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a simplified block diagram of a trade monitoring system according to various embodiments of the present disclosure.

FIG. 2 is a simplified block diagram of components used in the method according to embodiments of the present disclosure.

FIG. 3 illustrates the flow of data through communication analytics and trade analytics according to embodiments of the present disclosure.

FIG. 4 is a flowchart of a method according to embodiments of the present disclosure.

FIG. 5 illustrates a comparison of the base emotional profile to measured emotional scores according to embodiments of the present disclosure.

FIG. 6 is an exemplary display that presents detected emotions according to embodiments of the present disclosure.

FIG. 7 is a conversation that is analyzed according to embodiments of the present disclosure.

FIG. 8 is a block diagram of a computer system suitable for implementing one or more components in FIGS. 1-3 according to one embodiment of the present disclosure.

### DETAILED DESCRIPTION

This description and the accompanying drawings that illustrate aspects, embodiments, implementations, or applications should not be taken as limiting—the claims define the protected invention. Various mechanical, compositional, structural, user interface, electrical, and operational changes may be made without departing from the spirit and scope of this description and the claims. In some instances, well-known circuits, structures, or techniques have not been shown or described in detail as these are known to one of ordinary skill in the art.

In this description, specific details are set forth describing some embodiments consistent with the present disclosure. Numerous specific details are set forth in order to provide a thorough understanding of the embodiments. It will be apparent, however, to one of ordinary skill in the art that some embodiments may be practiced without some or all of these specific details. The specific embodiments disclosed herein are meant to be illustrative but not limiting. One of ordinary skill in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

According to various embodiments, the present invention uses emotion recognition to understand trader or employee behavior. Emotion recognition is a non-intrusive method and uses advanced learning algorithms to analyze a recorded voice to detect sentiment and human emotions (like anger, excitement, or joy) expressed during a call. The present invention leverages call recording technology and introduces voice analytics to detect emotion.

In several embodiments, the present methods and systems attempt to understand and map the emotional state of a person. In an exemplary embodiment, the present methods and systems use a person's telephonic conversations and voice for emotion recognition. Advantageously, the present methods and systems leverage the data already collected by firms. Trading firms like banks, stockbrokers, investment managers, and commodity derivative firms are already required to record and retain telephonic conversations.

In various embodiments, the present methods and systems use these telephonic conversations to extract emotions that can predict potential trade risk. In certain embodiments, the solution uses eight core emotions and attempts to detect each of these emotions. Based on the confidence of the emotions detected, the present invention generates a score for a participant in such a conversation that is compared to base scores for that participant or a selected group of participants. Base scores are calculated from previous telephonic conversations of the same participant or selected group.

In case of manipulation, a trader is expected to deviate from base scores and score higher on one or more of the emotions. For example, a trader participating in an insider trading situation will experience higher than normal anticipation and joy. Insider trading is when a trader uses non-public information to trade and profit. A person who is trading on insider information or collusive information will tend to display emotions like excitement, fear, or joy. In such cases, the trader's score for anticipation and joy will increase, and this helps a trade analyst spot and review potential issues. In contrast, a trader that is placing customer orders as part of routine work will generally lack such emotions. Thus, behavioral anomalies can be spotted by comparing the trader's emotional state versus a profile of regular traders or a base emotional profile of the trader. In this way, emotion recognition using voice analysis is used for monitoring trades or detecting potential market manipulation.

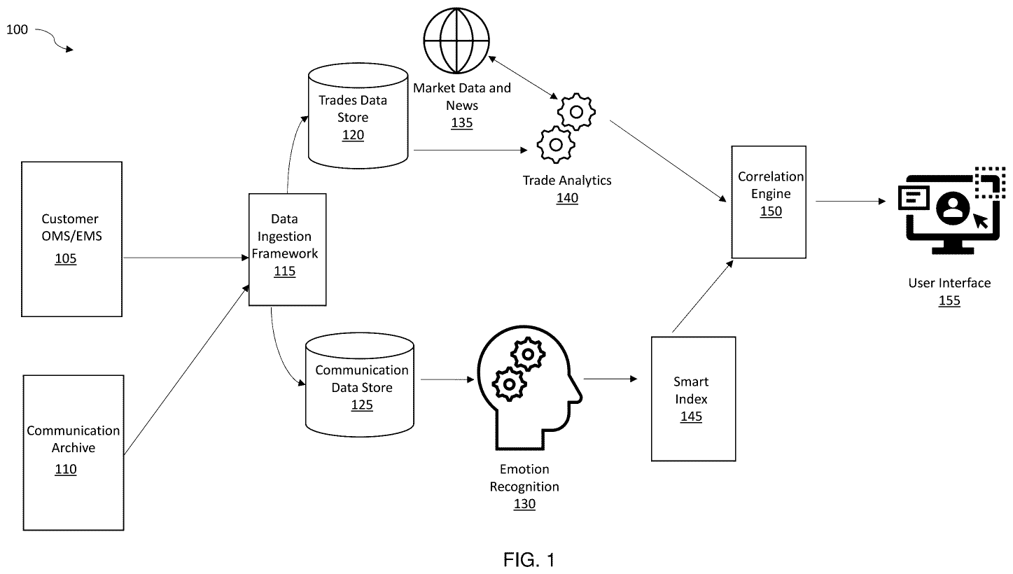

FIG. 1 illustrates a block diagram of an overall trade monitoring system 100. Trade monitoring system 100 includes Customer Order Management System/Execution Management System (OMS/EMS) 105, Communication Archive 110, Data Ingestion Framework 115, Trades Data Store 120, Communication Data Store 125, Emotion Recognition Engine 130, Market Data and News 135, Trade Analytics 140, Smart Index 145, Correlation Engine 150, and User Interface 155. Customer OMS/EMS 105 stores all the trades that are ordered or executed in the market. Communication Archive 110 stores all the telephonic/voice communications involving the traders. Data Ingestion Framework 115 allows the extraction, transformation and loading of customer trade communication data into a format that can be used for analysis. Trades Data Store 120 is the internal data store to replicate customer data. This is used when any data needs to be reanalyzed and protected, and data recovered in case of issues. Market Data and News 135 are optional third-party data sources that can add additional value. Emotion Recognition Engine 130 is an important aspect of the present invention, which leverages voice analysis to extract emotions of the participant, e.g., the trader. Smart Index 145 is a store for voice analysis results along with communication metadata like identifiers of voice call, dates, speakers, etc. Trade Analytics Engine 140 identifies potentially risky trades based on the timing of the trade compared to the market conditions or anomalies in price, quantity, or timing of the trade. Correlation Engine 150 is a system that analyzes results of trade monitoring and emotion recognition together to determine if there is any potential or attempted manipulation. User Interface 155 is an interactive graphical user interface for supervisors and/or investigators to review the results provided by Correlation Engine 150. Trade monitoring system 100 illustrates the use of a combination of trade analytics from Trade Analytics Engine 140 and emotion analysis from Emotion Recognition Engine 130 to detect anomalies in trades. In some embodiments, a combination of trade analysis with textual and speech analysis creates a true intent solution on the market.

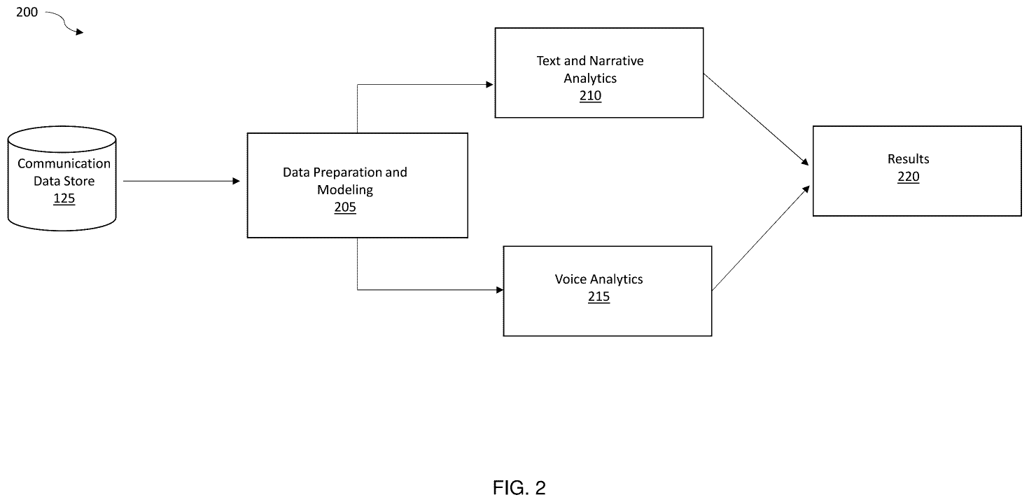

FIG. 2 illustrates the details of various preferred components that may be used in the present invention. Communication Data Store 125 is the internal store for client communication data, including audio communications. Files are stored in native format such as audio files in Waveform Audio File Format (WAV) or a similar format. Data Preparation and Modeling 205 is the component that prepares and converts data for modeling and analysis. Data and Preparation Modeling 205 converts audio files from the WAV format into a machine readable format for further analysis. In one embodiment, the audio files are converted into log-mel spectrograms. A spectrogram is a time versus frequency representation of an audio signal, and different emotions exhibit different patterns in the energy spectrum. In an exemplary embodiment, log-mel spectrograms are extracted for every audio file and then fed into a Convolutional Neural Network (CNN) model for training. New calls are then fed into the trained CNN model, and the trained CNN model identifies different emotions in the new calls based on the training data. Data Preparation and Modeling 205 also involves the use of speech to text algorithms to convert audio files into text. Voice Analytics 215 compares the extracts from Data Preparation and Modeling 205 to identify the emotions by comparing the results to training data. Text and Narrative Analytics 210 detects and identifies key words and phrases from the text prepared by Data Preparation and Modeling 205. Results 220 are extracts that are stored for further analysis, including extracted emotions and scoring for different emotions detected by Voice Analytics 215. Results 220 also include a final transcript of an audio communication with detected emotions, text, and the results of the textual analysis.

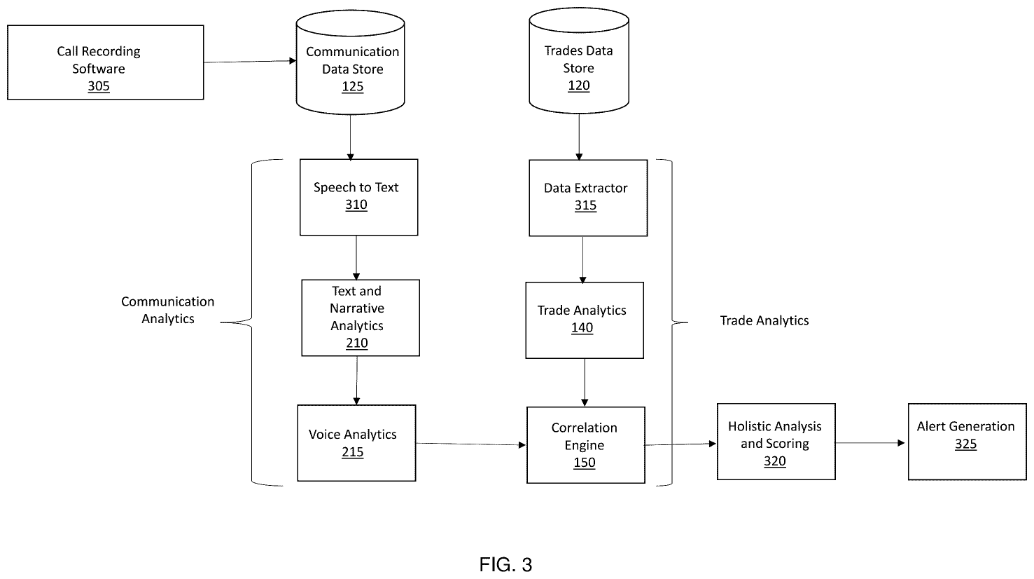

Referring now to FIG. 3, shown is flow of data through a communication analytics side and a trade analytics side of a trade monitoring system. Call Recording Software 305 feeds audio communications to Communication Data Store 125. Each audio communication is read from the Communication Data Store 125 along with the metadata of the communication. The metadata includes data like call participant identifiers, date and time of the call, type of device used, etc. Speech to text algorithms 310 convert the audio communication into text format for Text and Narrative Analytics 210, which includes natural language processing. Using Text and Narrative Analytics 210 and based on keywords used, certain risks like front running or insider trading can be detected. The next step is to pass the audio communication into Voice Analytics 215 for emotion detection and detection of anomalies. The analysis and results from Voice Analytics 215 is provided to Correlation Engine 150.

On the trade analytics side, Trades Data Store 120 provides information regarding trades to Data Extractor 315, which extracts keywords and phrases from trades. This data is then fed into Trade Analytics 140, where the keywords and phrases are analyzed to determine the potential for securities fraud. The analysis and results from Trade Analytics 140 is provided to Correlation Engine 150.

The results from Voice Analytics 215 and Trade Analytics 140 are then correlated using Correlation Engine 150, and fed into Holistic Analysis and Scoring Engine 320 for final scoring. The task of Correlation Engine 150 is to package the potentially risky audio communications and trades together for the investigator or analyst for Alert Generation 325.

To truly identify intent requires understanding of a person's emotional and mental state. It is important to analyze how people say things and not to simply analyze the content. Analyzing trades in isolation doesn't tend to reveal the intent of the trade and also doesn't tend to provide insights into the trader's conduct.

To truly detect the intent of trades and traders' conduct, a contextual approach to trade monitoring is effective. How people talk is an indicator of how people behave and can potentially reveal their actions. By analyzing the communications of people and their voice patterns, a behavioral image of the traders can be analyzed and such rogue traders can be spotted. For example, a trader who is trading on insider information will display emotions like excitement, happiness, and/or joy. A trader who is trying to execute a price manipulation scheme, if successful would likely engage in bragging and display an emotion like joy.

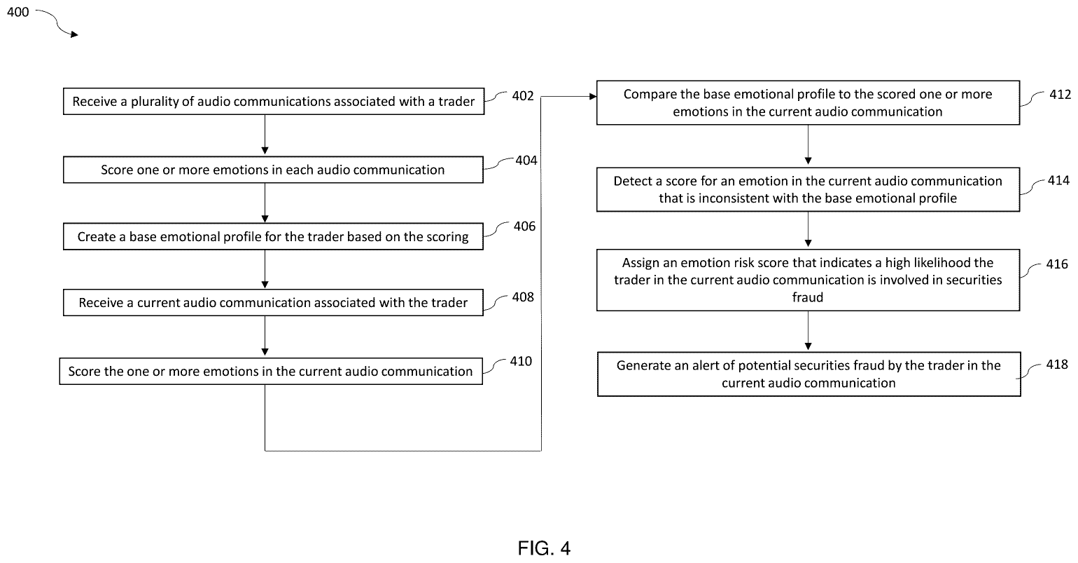

Referring now to FIG. 4, a method 400 according to embodiments of the present disclosure is described. At step 402, Voice Analytics 215 receives a plurality of audio communications associated with a trader. Customers can interact with traders in many ways. They can use a chat channel or a web-based interface to inquire and place orders. Alternatively, customers can also call their trading counterparts to inquire about the products and based on the quoted price, continue with order placement.

At step 404, Voice Analytics 215 scores one or more emotions in each audio communication. Audio communications can include, but are not limited to, call interactions (e.g., via traditional telephones, a cellular telephone, or a personal computing device), voice over IP (“VoIP”), video interactions, or internet interactions. In one or more embodiments, the emotions may include anger, anticipation, joy, trust, fear, surprise, sadness, and disgust. Multiple emotions can be detected in a single audio communication. For example, part of the audio communication can be classified as anger or joy, as emotions may change over the course of a voice communications.

In an exemplary embodiment, Voice Analytics 215 detects and classifies emotions using a CNN model, such as the VGG16 algorithm, a CNN model developed by Karen Simonyan and Andrew Zisserman at the University of Oxford. Voice Analytics 215 uses this model to extract and classify emotions from audio files.

In one embodiment, Voice Analytics 215 uses a windowing technique to sample a portion of the audio communication and treats each portion as an individual audio signal for analysis. The results are then combined and fed into the next step for profiling.

At step 406, Voice Analytics 215 creates a base emotional profile for the trader based on the scoring. Each trader has a unique personality and displays a baseline combination of the eight core emotions. For example, some individuals are optimistic and display positive emotions like trust or joy, while there are other individuals who could be generally bad-tempered and characterized by emotions like anger. On a normal business day, the emotions will usually correspond to the person's profile, but there could be variations based on the person's mental state. Similarly, people who are engaged in trading will have common characteristics with their peers who are also executing similar job duties.

To build a profile, Voice Analytics 215 may leverage the metadata (like participant ID and date/time) collected in the call recording process and the results of the classification generated in step 404. Voice Analytics 215 aggregates the detected emotions across the exemplary eight core categories for each trader to create a base emotional profile for that trader. Table 1 below is a sample base emotional profile for sample call participant Mike 2190.

TABLE 1
BASE EMOTIONAL PROFILE

| | | Count | Max | Min | | Last | First |
|---|---|---|---|---|---|---|---|
| Participant | Emotion | Overall | Daily | Daily | Average | Detected | Detected |
| Mike2190 | anger | | | | | | |
| Mike2190 | anticipation | 1000 | 15 | 0 | 6 | Apr. 12, 2022 | May 11, 2001 |
| Mike2190 | joy | | | | | | |
| Mike2190 | trust | 2500 | 40 | 25 | 37 | Jul. 12, 2022 | May 11, 2001 |
| Mike2190 | fear | 500 | 10 | 0 | 0 | Dec. 21, 2002 | May 11, 2001 |
| Mike2190 | surprise | 800 | 27 | 0 | 0 | Mar. 9, 2013 | May 11, 2001 |
| Mike2190 | sadness | 10 | 1 | 1 | 0 | Feb. 5, 2020 | Nov. 21, 2007 |
| Mike2190 | disgust | | | | | | |

Using the above base profile as an example, it can be seen that many of the rows/emotions like anger and disgust are blank, or have no data collected. This means that these are not registered emotions for the participant, e.g., a trader. Similarly, the first and last detected dates of emotions can be seen. These features help a user understand if the emotions are consistently registered or if they are sporadic instances. For example, in the above table, sadness was last registered in the year 2020 and has overall low counts. Another important point to note about sporadic detected emotions is that the average for such features is trending towards zero. This means that, compared to the overall number of calls, these emotions are detected on a very few calls, thus the average is very low or zero. Emotions like trust and anticipation are dominant emotions that characterize the participant, and these are the expected emotions in new calls that are analyzed.

In one or more embodiments, Voice Analytics 215 determines, from the base emotional profile, which emotions characterize the trader. In the example of Table 1, the dominant emotions are trust and anticipation.

At step 408, Voice Analytics 215 receives a new or current audio communication associated with the trader. In one or more embodiments, the plurality of audio communications and the current audio communication are converted into an image before scoring the one or more emotions. The first step in the emotion detection process is typically to convert the audio files into a format that is readable by a machine learning model. This process is called the generation of spectrograms, which is simply a process that converts an audio file into an image. The image file is then fed into a machine learning model that classifies the audio communication into one or more of the eight core emotions.

At step 410, Voice Analytics 215 scores one or more emotions in the current audio communication using the techniques described in step 404.

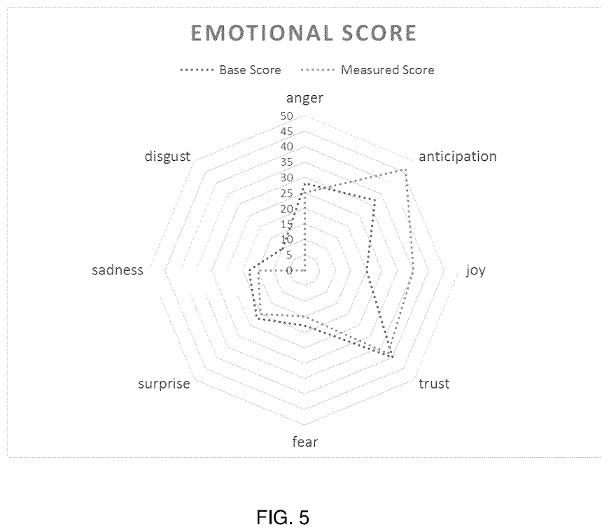

At step 412, Voice Analytics 215 compares the base emotional profile to the scored one or more emotions in the current audio communication. FIG. 5 illustrates a comparison of the base emotional profile of a trader to the measured emotional scores for a current audio communication.

At step 414, Voice Analytics 215 detects a score for an emotion in the current audio communication that is inconsistent with the base emotional profile. In the example of FIG. 5, the scores of anticipation and joy are greater than the base scores for these emotions. Fear is also an emotion that may also be inconsistent with the base emotional profile. Voice Analytics 215 in this step detects unusual emotions. Unusual means that the process detects emotions inconsistent with the expected profile of the trader. For example, a trader in general displays trust and joy, and these are the trader's predominant emotions. If suddenly the trader displays the emotion of fear, and it is dominant over time, it could indicate that the trader perhaps is fearful of losing his job or having a low performance, or of being caught for engaging in a prohibited trade or series of trades.

At step 416, Voice Analytics 215 assigns an emotion risk score that indicates a high likelihood the trader in the current audio communication is involved in securities fraud. “Securities Fraud” coves a wide range of illegal activities that involve the deception of investors or the manipulation of financial markets. Examples of securities fraud include, but are not limited to, front running and insider trading. Traders have the potential to engage in manipulation or fraud. For example, after receiving a customer order, instead of placing the customer's order, the trader can trade ahead of such order (front running) to benefit herself or another before the customer. There is also potential to receive nonpublic information and to trade on that information.

For each new incoming audio communication, as described in the above steps, Voice Analytics 215 extracts the emotions demonstrated in the speech. In FIG. 5, there are new emotions that are being detected that are not consistent with the trader's base emotional profile. Voice Analytics 215 flags this call as an anomaly and generates a high emotion risk score as an indication of potential manipulation. A “high emotion risk score” means a score between 70 to 100 on a 100 point scale, and the like. In various embodiments, a “high emotion risk score” is a deviation from the emotions found in the trader profile versus past emotions over time and in comparison with peer emotional behavior.

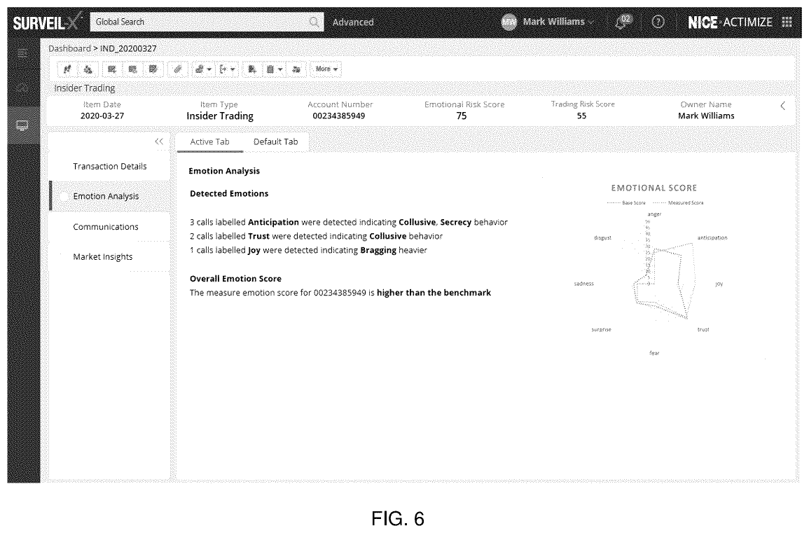

At step 418, Alert Generation 325 generates an alert of potential securities fraud by the trader in the current audio communication. In various embodiments, Alert Generation 325 generates a display with the results of the emotion analysis for a user. FIG. 6 is an exemplary display that presents the emotions and mapped behaviors that were detected in the audio communications of a trader. The display also includes the emotion risk score. In the example of FIG. 6, the emotion of joy is associated with bragging. The information displayed, along with trade and communication details, helps a compliance analyst, supervisor, investigator, or other user of the system and methods described herein to understand a trader's intent and how to deal with the alert.

To protect against potential securities fraud, surveillance systems are often leveraged. Surveillance systems leverage both the trade data from Customer OMS/EMS 105 and also the recorded phone calls from Communication Archive 110. To record phone calls or voice audio, financial institutions use Call Recording Software 305. Such software records the voice conversations and stores data into Communication Archive 110. The audio is typically recorded in a mp3 or WAV format. In addition to recording the audio of the call, the Call Recording Software 305 also collects meaningful data like call participants, data and time of call, type of device used, etc. All of this metadata is captured and stored in Communication Archive 110. Similarly, Customer OMS/EMS 105 captures details of the requested trade including, but not limited to, traded product, date and time of order, quantity, price, buy or sell order, etc.

Monitoring or surveillance systems use data from these archives and process them via detection engines to generate alerts in case of potential manipulation or suspected fraud. The detection engines generate alerts that are reviewed manually by an analyst or other user. Most systems in the market conduct independent analysis of the trade and communication data (e.g., Trades Data Store 120 and Communication Data Store 125). Treating these datasets independently, however, creates potentially two alerts for the same scenario or could result in missing potential fraud since not all the data is analyzed. Based on customer estimates, a Tier 1 financial institution generates about 20,000 voice calls per day and up to 5 million trades. Assuming an alert rate of 0.5%, 1.00 communication alerts and 25,000 trade alerts are created on a daily basis. Since these alerts need to be manually reviewed, it creates a huge workload for the analysts and other users. Therefore, many trading firms resort to random sampling of alerts, and many true cases of manipulation are not detected as a result using conventional systems but with the present system and methods more targeted sampling can be conducted.

Some companies perform a holistic analysis of data, i.e., they correlate the trade and surveillance data sets and generate a single alert. Such a technique provides a better detection given that all the information that goes into the trade is analyzed. While this technique is efficient and provides investigators a lot of details including a timeline of events, communication details relevant for the trade, including trade details and information about the stock market, it still lacks one key component—intent. It is important to detect the intent behind a trade. By adding intent (emotion analysis), an investigator reviewing the alert manually can get additional insights into the events and make a justification if the alert was truly an attempted manipulation and should be reviewed further or it was a false positive and can be dismissed.

Accordingly, in one or more embodiments, additional communication analytics are performed on the current audio communication. In an embodiment, the current audio communication is converted to text, Text and Narrative Analytics 210 identifies keywords or key phrases in the text, and Text and Narrative Analytics 210 assigns a communication risk score based on the identified keywords or key phrases. Moreover, in some embodiments, trade analytics are also performed on the current audio communication. In various embodiments, Trade Analytics 140 reviews trade transactions executed by the trader, reviews the timing of the executed trade transaction, and assigns a trade risk score based on the timing of the executed trade transaction. In an exemplary embodiment, Correlation Engine 150 correlates the trade risk score, the communication risk score, and the emotion risk score to identify a likelihood that the trader in the current audio communication is involved in securities fraud.

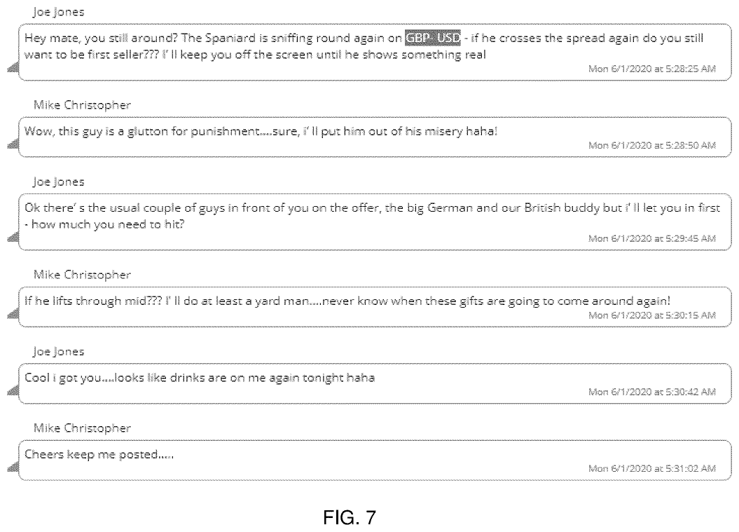

The additional analytics performed is further explained with respect to the conversation shown in FIG. 7. Reviewing the text of this call, Mike and Joe are discussing the potential of front running another customer (“the Spaniard”). Text and Narrative Analytics 210 uses natural language processing to determine that the traders are discussing a product called GBP-USD. This is a potential front running manipulation scenario as evidenced by the text phrases “usual couple of guys ahead of you . . . I'll let you in first.” Text and Narrative Analytics 210 adds a communication risk score of 80/100.

The potential of executing a profitable trade by abusing proprietary client information and trading ahead seems to be exciting for Mike. The below emotions are extracted by Voice Analytics 215. Joy, as evidenced by some of the text “put him out of his misery . . . ha.” Anticipation, as evidenced by “Cheers keep me posted.” By comparing the emotions detected in this audio communication to Mike's expected or base emotional profile Voice Analytics 215 can spot the anomalies and flag this as a risk. Voice Analytics 215 adds an emotion risk score of 70/100 due to unusual emotions detected in the call.

Trade Analytics 140 reviews the trades executed by Mike and compares that to the trades of the customer (“the Spaniard”). Trade Analytics 140 detects the timing of the executions and spots the pattern of Mike trading ahead of the customer. Trade Analytics 140 adds a trade risk score of 90/100 due to the detected pattern.

Holistic Analysis and Scoring 320 can now create a more complete picture of the events and potential legal violations by correlating the trade risk, communication risk, and emotional risk scores. Each of these scores in isolation is an indicator of potential risk, but is not conclusive. For example, text analysis can be fooled by key phrases like “I'll let you in first” or “let you in on a secret” because these phrases could mean a non-business related social discussion or merely an attempt to persuade a customer they are getting a favored deal. Thus, alerting on communication risk in the absence of emotion or trade risk could generate false alerts. Similarly, trade analytics timing based risk could be pure coincidence without any knowledge of upcoming client trades. The communication risk and emotion risk provides the full context to the events and justification for the alerts. In the process, Holistic Analysis and Scoring 320 generates fewer false positives and better quality alerts reducing the overall effort for an investigator and detects more relevant risks.

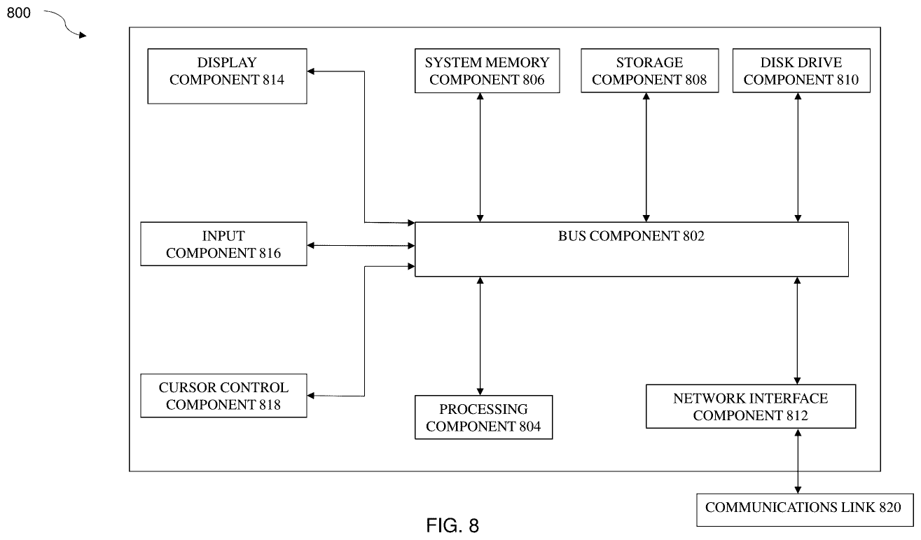

Referring now to FIG. 8, illustrated is a block diagram of a system 800 suitable for implementing embodiments of the present disclosure. System 800, such as part a computer and/or a network server, includes a bus 802 or other communication mechanism for communicating information, which interconnects subsystems and components, including one or more of a processing component 804 (e.g., processor, micro-controller, digital signal processor (DSP), etc.), a system memory component 806 (e.g., RAM), a static storage component 808 (e.g., ROM), a network interface component 812, a display component 814 (or alternatively, an interface to an external display), an input component 816 (e.g., keypad or keyboard), and a cursor control component 818 (e.g., a mouse pad).

In accordance with embodiments of the present disclosure, system 800 performs specific operations by processor 804 executing one or more sequences of one or more instructions contained in system memory component 806. Such instructions may be read into system memory component 806 from another computer readable medium, such as static storage component 808. These may include instructions to receive a plurality of audio communications associated with a trader; score one or more emotions in each audio communication; create a base emotional profile for the trader based on the scoring; receive a current audio communication associated with the trader; score the one or more emotions in the current audio communication; compare the base emotional profile to the scored one or more emotions in the current audio communication; detect a score for an emotion in the current audio communication that is inconsistent with the base emotional profile; assign an emotion risk score that indicates a high likelihood the trader in the current audio communication is involved in securities fraud; and generate an alert of potential securities fraud by the trader in the current audio communication. In other embodiments, hard-wired circuitry may be used in place of or in combination with software instructions for implementation of one or more embodiments of the disclosure.

Logic may be encoded in a computer readable medium, which may refer to any medium that participates in providing instructions to processor 804 for execution. Such a medium may take many forms, including but not limited to, non-volatile media, volatile media, and transmission media. In various implementations, volatile media includes dynamic memory, such as system memory component 806, and transmission media includes coaxial cables, copper wire, and fiber optics, including wires that comprise bus 802. Memory may be used to store visual representations of the different options for searching or auto-synchronizing. In one example, transmission media may take the form of acoustic or light waves, such as those generated during radio wave and infrared data communications. Some common forms of computer readable media include, for example, RAM, PROM, EPROM, FLASH-EPROM, any other memory chip or cartridge, carrier wave, or any other medium from which a computer is adapted to read.

In various embodiments of the disclosure, execution of instruction sequences to practice the disclosure may be performed by system 800. In various other embodiments, a plurality of systems 800 coupled by communication link 820 (e.g., LAN, WLAN, PTSN, or various other wired or wireless networks) may perform instruction sequences to practice the disclosure in coordination with one another. Computer system 800 may transmit and receive messages, data, information and instructions, including one or more programs (i.e., application code) through communication link 820 and communication interface 812. Received program code may be executed by processor 804 as received and/or stored in disk drive component 810 or some other non-volatile storage component for execution.

The Abstract at the end of this disclosure is provided to comply with 37 C.F.R. § 1.72(b) to allow a quick determination of the nature of the technical disclosure. It is submitted with the understanding that it will not be used to interpret or limit the scope or meaning of the claims.

What is claimed is:

1. A trade monitoring system comprising:
a processor and a computer readable medium operably coupled thereto, the computer readable medium comprising a plurality of instructions stored in association therewith that are accessible to, and executable by, the processor, to perform operations which comprise:
receiving a plurality of audio communications associated with a trader;
scoring one or more emotions in each audio communication;
creating a base emotional profile for the trader based on the scoring;
receiving a current audio communication associated with the trader;
scoring the one or more emotions in the current audio communication;
comparing the base emotional profile to the scored one or more emotions in the current audio communication;
detecting a score for an emotion in the current audio communication that is inconsistent with the base emotional profile;
assigning an emotion risk score that indicates a high likelihood the trader in the current audio communication is involved in securities fraud; and
generating an alert of potential securities fraud by the trader in the current audio communication.

2. The trade monitoring system of claim 1, wherein the operations further comprise converting the plurality of audio communications and the current audio communication into an image before scoring the one or more emotions.

3. The trade monitoring system of claim 1, wherein the one or more emotions comprises anger, anticipation, joy, trust, fear, surprise, sadness, or disgust.

4. The trade monitoring system of claim 3, wherein the detected score is associated with the emotion of anticipation, joy, or fear.

5. The trade monitoring system of claim 1, wherein the base emotional profile comprises when the one or more emotions was detected.

6. The trade monitoring system of claim 1, wherein the operations further comprise determining, from the base emotional profile, which of the one or more emotions characterize the trader.

7. The trade monitoring system of claim 1, wherein the operations further comprise:
converting the current audio communication to text;
identifying keywords or key phrases in the text; and
assigning a communication risk score based on the identified keywords or key phrases.

8. The trade monitoring system of claim 7, wherein the operations further comprise:
reviewing trade transactions executed by the trader;
reviewing timing of the executed trade transactions; and
assigning a trade risk score based on the timing of the executed trade transactions.

9. The trade monitoring system of claim 8, wherein the operations further comprise correlating the trade risk score, the communication risk score, and the emotion risk score to determine a likelihood that the trader in the current audio communication is involved in securities fraud.

10. A method for monitoring trades, which comprises:
receiving a plurality of audio communications associated with a trader;
scoring one or more emotions in each audio communication;
creating a base emotional profile for the trader based on the scoring;
receiving a current audio communication associated with the trader;
scoring the one or more emotions in the current audio communication;
comparing the base emotional profile to the scored one or more emotions in the current audio communication;
detecting a score for an emotion in the current audio communication that is inconsistent with the base emotional profile;
assigning an emotion risk score that indicates a high likelihood the trader in the current audio communication is involved in securities fraud; and
generating an alert of potential securities fraud by the trader in the current audio communication.

11. The method of claim 10, wherein the one or more emotions comprises anger, anticipation, joy, trust, fear, surprise, sadness, or disgust.

12. The method of claim 11, wherein the detected score is associated with the emotion of anticipation, joy, or fear.

13. The method of claim 10, which further comprises:
converting the current audio communication to text;
identifying keywords or key phrases in the text; and
assigning a communication risk score based on the identified keywords or key phrases.

14. The method of claim 13, which further comprises:
reviewing trade transactions executed by the trader;
reviewing timing of the executed trade transactions; and
assigning a trade risk score based on the timing of the executed trade transactions.

15. The method of claim 14, which further comprises correlating the trade risk score, the communication risk score, and the emotion risk score to determine a likelihood that the trader in the current audio communication is involved in securities fraud.

16. A non-transitory computer-readable medium having stored thereon computer-readable instructions executable by a processor to perform operations which comprise:
receiving a plurality of audio communications associated with a trader;
scoring one or more emotions in each audio communication;
creating a base emotional profile for the trader based on the scoring;
receiving a current audio communication associated with the trader;
scoring the one or more emotions in the current audio communication;
comparing the base emotional profile to the scored one or more emotions in the current audio communication;
detecting a score for an emotion in the current audio communication that is inconsistent with the base emotional profile;
assigning an emotion risk score that indicates a high likelihood the trader in the current audio communication is involved in securities fraud; and
generating an alert of potential securities fraud by the trader in the current audio communication.

17. The non-transitory computer-readable medium of claim 16, wherein the one or more emotions comprises anger, anticipation, joy, trust, fear, surprise, sadness, or disgust.

18. The non-transitory computer-readable medium of claim 16, wherein the operations further comprise:
converting the current audio communication to text;
identifying keywords or key phrases in the text; and
assigning a communication risk score based on the identified keywords or key phrases.

19. The non-transitory computer-readable medium of claim 18, wherein the operations further comprise:
reviewing trade transactions executed by the trader;
reviewing timing of the executed trade transactions; and
assigning a trade risk score based on the timing of the executed trade transactions.

20. The non-transitory computer-readable medium of claim 19, wherein the operations further comprise correlating the trade risk score, the communication risk score, and the emotion risk score to determine a likelihood that the trader in the current audio communication is involved in securities fraud.
